(19) United States
(12) Patent Application Publication
(10) Pub. No.: US 2012/0324902 A1
(43) Pub. Date: Dec. 27, 2012

(54) METHOD OF MAINTAINING SURFACE-RELATED PROPERTIES OF GAS TURBINE COMBUSTOR COMPONENTS

(75) Inventors: Stephen Gerard Pope, Roebuck, SC (US); Dennis William Cavanaugh, Simpsonville, SC (US)

(73) Assignee: GENERAL ELECTRIC COMPANY, Schenectady, NY (US)

(21) Appl. No.: 13/169,310

(22) Filed: Jun. 27, 2011

(51) Int. Cl. F02C 7/00; B23P 11/00; B05D 3/02

(52) U.S. Cl. 60/772; 427/372.2; 427/380; 29/889.2; 60/752

(57) ABSTRACT

A method and coating for maintaining surface-related properties of a gas turbine combustor component having a wall formed of a nickel-base alloy containing a gamma prime precipitate strengthening phase, interior and exterior surfaces defined by the wall, and at least one hole in the wall that fluidically connects the interior and exterior surfaces of the combustor component. A diffusion coating composition is applied at least within the hole, and then heated to form a diffusion aluminide coating in at least an in-wall surface region of the wall that surrounds and defines the hole. The aluminiding coating forms a diffusion zone that contains a sufficient amount of aluminum intermetallics to inhibit depletion of the gamma prime precipitates in the wall and inhibit degradation and cracking in the in-wall surface region surrounding the hole.

### BACKGROUND OF THE INVENTION

The present invention generally relates to hardware of gas turbines, and more particularly to a coating and method capable of maintaining surface-related properties of gas turbine combustor components.

FIG. 1 schematically represents a side view of a transition piece 10 of a type used in combustors of industrial gas turbine engines. The transition piece 10 has an inlet end 12 through which hot combustion gases from a combustor (not shown) are received, and an outlet end 14 through which the combustion gases flow from the transition piece 10 into the turbine section (not shown) of the engine. The transition piece 10 and its associated combustor form an assembly that is typically one of multiple combustor assemblies located about the periphery of an industrial gas turbine engine.

Emissions produced by gas turbines burning conventional hydrocarbon fuels contain carbon monoxide, unburned hydrocarbons, and oxides of nitrogen (NOₓ). The production of NOₓ is the result of oxidation of molecular nitrogen, which is dependent in part upon the temperature of the stream of hot combustion gases that are produced by the combustor and flow through the transition piece 10. Various concepts have been proposed and utilized to maintain the reaction zone temperatures below the level at which NOₓ is formed or by reducing the residence time of combustion gases at high temperatures. As schematically represented in FIG. 1, one such technique involves the introduction of dilution air into the transition piece 10 through dilution holes 16. In the example of FIG. 1, three dilution holes 16 are shown as being present in the transition piece 10, though the use of fewer or greater numbers of dilution holes 16 are also possible. The source of the dilution air is compressor discharge air that is typically delivered to a cavity defined by the exterior of the transition piece 10 and a casing that surrounds the combustor assembly. The size and placement of the dilution holes 16 are very important in terms of successfully tuning the combustion system of an industrial gas turbine engine.

Superalloys are widely used to form components of turbomachinery, including the combustor assemblies of industrial gas turbine engines. Nonlimiting examples include NIMONIC® 263 and C263, which are precipitation hardenable nickel-chromium-cobalt alloys. Both alloys are well-documented for use in gas turbine combustor components, and exhibit such desirable properties as high strength, corrosion resistance and high temperature ductility. C263 has a reported nominal composition of, by weight, 19-21% chromium, 19-21% cobalt, 5.6-6.1% molybdenum, 1.9-2.4% titanium, 0-0.6% aluminum (2.4-2.8% Al+Ti), 0.04-0.08% carbon, 0-0.6% manganese, 0-0.2% copper, 0-0.005% boron, 0-0.7% iron, 0-0.4% silicon, the balance nickel and incidental impurities. The precipitation phases in the 263 and C263 alloys (and other precipitation-strengthened nickel-base alloys) are an intermetallic phase in which aluminum (and/or titanium, if present) is the principal element that combines with nickel to form a fcc gamma prime (γ′) precipitate (principally Ni₃(Al,Ti)), which precipitates coherently with the gamma (γ) austenitic fcc matrix phase of nickel-base alloys. The gamma prime precipitate phase, which is generally about 10 volume percent in 263 and C263, promotes the high temperature strength and creep resistance of nickel-base alloys.

The transition piece 10 and other components of the combustor assembly are often protected by a thermal barrier coating (TBC), which reduces the temperature of the underlying component substrate and thereby prolongs the service life of the component. Ceramic materials and particularly yttria-stabilized zirconia (YSZ) are widely used as TBC materials because of their high temperature capability, low thermal conductivity, and relative ease of deposition. TBCs are typically applied to the interior surfaces of the transition piece 10 so that, typically in combination with backside cooling, the temperature of the transition piece 10 can be maintained at a temperature below the melting temperature of the superalloy from which it is formed.

The dilution holes of transition pieces of the type represented in FIG. 1 have been found to be subject to damage resulting from high temperatures. For example, dilution holes formed in transition pieces formed of NIMONIC® C263 have exhibited signs of degradation and cracking Current techniques for addressing this issue have included attempts to control the temperature of the edges surrounding the dilution holes 16. However, such attempts are not always successful and can lead to undesirable design constraints. As continued advancements in gas turbine technology result in higher operating temperatures, there is a tendency to produce gas turbine components from more advanced and more expensive alloys. However, it would be desirable if the edges of diffusion holes could be protected from degradation and cracking while allowing the continued use of well-known and reliable alloys, such as NIMONIC® C263.

### BRIEF DESCRIPTION OF THE INVENTION

The present invention generally provides a method and coating for maintaining surface-related properties of gas turbine combustor components, and more particularly to inhibit degradation and cracking in an edge surrounding a hole in a gamma prime-strengthened nickel-base alloy, for example, a dilution hole in a transition piece of an industrial gas turbine engine.

According to a first aspect of the invention, a combustor component has a wall formed of a nickel-base alloy containing aluminum and a gamma prime precipitate strengthening phase, interior and exterior surfaces defined by the wall, and at least one hole in the wall that extends from the exterior surface to the interior surface so that an in-wall surface region of the wall defines the hole and the hole fluidically connects the interior and exterior surfaces of the combustor component. The method includes selectively applying a diffusion coating composition at least within the hole, and then heating the diffusion coating composition to form a diffusion aluminide coating in at least the in-wall surface region of the wall. The aluminiding coating comprises a diffusion zone that contains aluminum intermetallics, which provide a reservoir for aluminum that is depleted from the nickel-base alloy. The diffusion zone contains a sufficient amount of the aluminum intermetallics to inhibit depletion of the gamma prime precipitates in the wall and inhibit degradation and cracking in the edge surrounding the hole.

Another aspect of the invention is a combustor component provided with the diffusion aluminide coating formed by a process comprising the steps described above.

A technical effect of the invention is the ability to inhibit degradation and cracking in the edge surrounding the hole of a combustor component by inhibiting the depletion of the gamma prime precipitates in the near-surface regions of the wall that define the edge of the hole. According to a particular aspect of the invention, degradation and cracking of dilution hole edges has been attributed to oxidation and the loss of beneficial precipitate microstructures due to the segregation and depletion of aluminum and potentially other elements necessary to form and maintain a desirable amount of the gamma prime precipitates in the wall surrounding the dilution holes. The diffusion coating provides a reservoir of such elements that reduces the likelihood that the wall will become depleted of these elements to the extent that cracking and degradation would result.

Other aspects and advantages of this invention will be better appreciated from the following detailed description.

### BRIEF DESCRIPTION OF THE DRAWINGS

FIG. 1 is a side view of a transition piece of an industrial gas turbine engine.

FIG. 2 schematically represents a cross-sectional view through a wall of the transition piece of FIG. 1 in which a dilution hole is present, and a diffusion coating composition applied within the dilution hole to produce a diffusion coating in an in-wall surface region of the wall that defines the diffusion hole.

FIG. 3 schematically represents a diffusion coating produced by the diffusion coating composition of FIG. 2.

FIGS. 4 and 5 are scanned images showing microstructures of two specimens of a gamma prime-strengthened nickel-base superalloy following identical extended thermal tests.

### DETAILED DESCRIPTION OF THE INVENTION

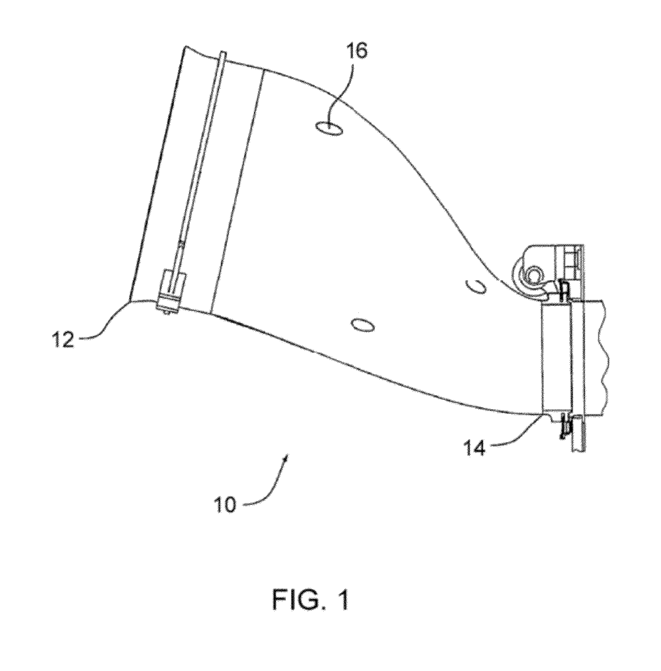

The present invention will be described with reference to the transition piece 10 discussed above in reference to FIG. 1. As such, the transition piece 10 has an exterior surface, an interior surface that is typically coated with a TBC or other coating system capable of thermally insulating the interior surfaces of the transition piece 10, and dilution holes 16 through which dilution air flows from the exterior surface of the transition piece 10 for the purpose of cooling hot combustion gases flowing through the transition piece 10. The size, number and placement of the dilution holes 16 are carefully controlled to achieve a desired tuning effect for the combustion system of the industrial gas turbine engine in which the transition piece 10 is installed. However, it should be understood that the invention is not limited to transition pieces having the specific configuration shown in FIG. 1, but instead is applicable transition pieces adapted for use in a variety of combustor configurations. Furthermore, it should become evident that the invention is not limited to transition pieces, but instead the benefits of the invention can be applied to other combustor components, for example, combustor liners and aft frames of transition pieces, as well as other high-temperature components having holes whose surfaces are subjected to degradation and cracking as a result of depletion of precipitates in a wall of the component surrounding the hole.

According to a preferred aspect of the invention, the transition piece 10 is formed of a gamma prime-strengthened nickel-base superalloy, particular examples of which are NIMONIC® 263 and C263, though the use of other alloys is also within the scope of the invention, particularly Udimet 500, GTD-111®, GTD-222® and GTD-444®. As such, the transition piece 10 is strengthened by the intermetallic gamma prime precipitate phase of principally Ni₃(Al,Ti). Depending on the particular composition of the nickel-base alloy, other elements may also contribute to and be present in the gamma prime phase.

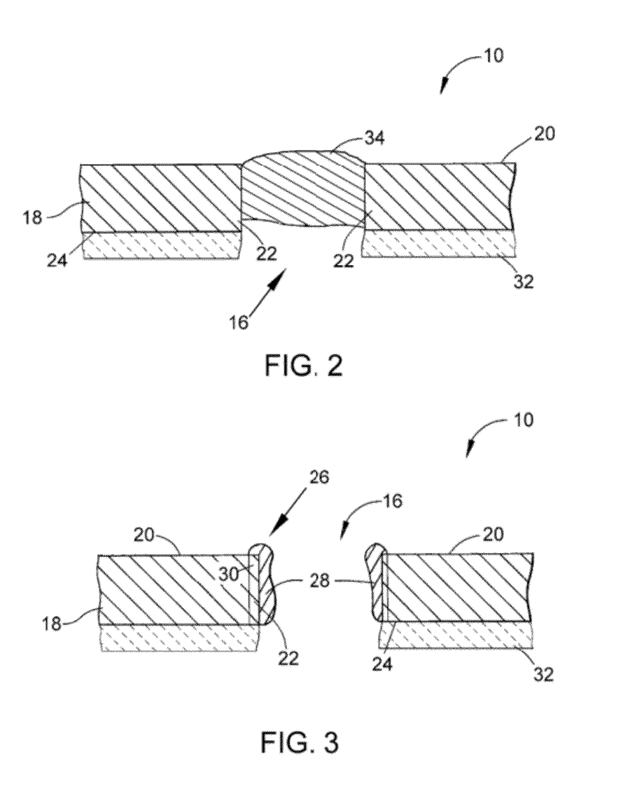

The invention is directed to inhibiting the degradation of a wall of the transition piece 10 immediately surrounding one or more of the dilution holes 16. FIG. 2 represents one of the dilution holes 16 of the transition piece 10 and a wall portion 18 of the transition piece 10 that surrounds and defines the dilution hole 16. In particular, the wall portion 18 includes an exterior surface 20 and an in-wall surface region 22 that defines and surrounds the hole 16 between the exterior surface 20 and an interior surface 24 of the transition piece 10. The diameter of the hole 16 will depend in part on the number and placement of the dilution holes 16 in the transition piece 10. Typical but nonlimiting diameters for the hole 16 are on the order of about 0.030 inch (about 0.8 mm) or more, though smaller diameter holes 16 are also possible. It should be noted that FIG. 2 is not to scale, and is merely intended to assist in an understanding of the invention.

In investigations leading up to the present invention, the presence of cracking and degradation of the wall portion 18 was correlated to the depletion of gamma prime precipitates in the in-wall surface region 22 of dilution holes 16 in transition pieces 10. While the interior surface 24 of the transition piece 10 is often protected from hot combustion gases within the transition piece 10 by a thermal barrier coating (not shown), the exterior surface 20 and in-wall surface region 22 surrounding the dilution hole 18 are typically not protected due to their lower temperatures resulting from the cooling effect of compressor discharge air used as the dilution air. According to the present invention, high temperature air and/or combustion gases are believed to sufficiently oxidize the exterior surface 20 and, in particular, the in-wall surface region 22 of the wall portion 18, gradually depleting the in-wall surface region 22 (which includes the surface within the hole 16 and the material of the wall portion 18 beneath this surface) of aluminum and other elements (for example, titanium) necessary for the gamma prime phase. Depletion of these elements within the in-wall surface region 22 has been found to deplete the amount of gamma prime phase in the in-wall surface region 22, reducing the thermal fatigue properties of the alloy and leading to radial cracking in the edges of dilution holes 16. Transformation of the gamma prime phase to the brittle eta (η) phase as also been observed. As known in the art, the eta phase is an intermetallic phase of nickel and titanium, Ni₃Ti, that in contrast to gamma prime (Ni₃(Al,Ti), has a hexagonal close-packed (HCP) structure that is non-coherent with the gamma matrix. The eta phase typically exists as large platelets that can extend across grains, and is typically undesirable in nickel-base superalloys. The eta phase is a transformation process that occurs over time at sufficiently high temperature due to the diffusion of aluminum and titanium. Generally, alloys with an Al/Ti ratio above 1.0 typically do not form eta phase, though the exact ratio is alloy dependent. As a conservative estimate, the Al/Ti ratio above which eta phase forms in NIMONIC® 263 and C263 is approximately 0.6.

To counteract the depletion of aluminum in the in-wall surface region 22, the present invention provides a reservoir of aluminum in the form of a diffusion aluminide coating 26, represented in FIG. 3. As known in the art, diffusion aluminide coatings are environmentally-resistant coatings formed by a diffusion process, for example, pack cementation, vapor phase (gas phase) aluminiding (VPA), or chemical vapor deposition (CVD). The diffusion process generally entails reacting a surface with an aluminum-containing vapor to form two distinct zones, an outermost of which is an additive layer that contains the environmentally-resistant intermetallic phase MAl, where M is iron, nickel or cobalt, depending on the substrate material (mainly β(NiAl) if the substrate is Ni-base). Beneath the additive layer is a diffusion zone (DZ) that typically extends about 25 to 50 micrometers into the substrate. The diffusion zone is an aluminum-rich region that contains various intermetallic and metastable phases, including MAl (mainly β(NiAl)), gamma prime (Ni₃Al) and gamma (Ni solid solution) phases (if the substrate is Ni-base). In the example of FIG. 3, the diffusion aluminide coating 26 is represented as having an additive layer 28 and a diffusion zone 30. During high temperature exposures in air, the additive layer 28 forms a protective aluminum oxide (alumina; Al₂O₃) scale that inhibits oxidation of the diffusion coating 26 and the in-wall surface region 22. As used herein, the diffusion aluminide coating 26 may contain additional elements intended to modify the properties of the coating 26, nonlimiting examples of which include silicon, hafnium, and palladium.

While diffusion aluminide coatings are known and widely used, a complication with the transition piece 10 is the small size of the dilution hole 16 in which the in-wall surface region 22 requiring protection is located, as well as the presence of a thermal barrier coating (TBC) system 32 on the interior surface 24 of the transition piece adjacent the in-wall surface region 22. To avoid the complexities of attempting to form a suitable diffusion aluminide coating using conventional vapor or pack aluminide processes, the present invention utilizes a coating process, which as represented in FIG. 2 involves the use of a slurry, gel, paint, tape or other aluminide coating composition 34 that can be selectively deposited within the dilution hole 16 to selectively form the diffusion aluminide coating 26 on and in the in-wall surface region 22 within the dilution hole 16, and optionally a portion of the exterior surface 20 immediately surrounding the dilution hole 16.

Various processes can be used to form the diffusion aluminide coating 26 in the in-wall surface region 22, examples of which include those disclosed in U.S. Published Patent Application Nos. 2009/0214773 and 2009/0126833, though it is foreseeable that other diffusion aluminide processes could be used. According to a preferred aspect of the invention, the coating composition 34 contains one or more donor materials containing metallic aluminum, one or more halide activators, and one or more binders containing at least one organic polymer. Notably missing from the ingredients of the coating composition 34 are inert fillers and inorganic binders, whose particles are prone to sintering and becoming attached to surfaces being coated. Suitable donor materials are aluminum alloys with higher melting temperatures than aluminum (melting point of about 660° C.). Particularly suitable donor metals include metallic aluminum alloyed with chromium, cobalt, iron, and/or another aluminum alloying agent with a sufficiently higher melting point so that the alloying agent does not deposit during the diffusion aluminiding process, but instead serves as an inert carrier for the aluminum of the donor material. Preferred donor materials are chromium-aluminum alloys. An alloy that appears to be particularly well-suited for diffusion processes performed over the wide range of temperatures contemplated by this invention is believed to be 56Cr-44Al (about 44 weight percent aluminum, the balance chromium and incidental impurities). A preferred particle size for the donor material powder is −200 mesh (a maximum dimension of not larger than 74 micrometers), though it is foreseeable that powders with a mesh size of as large as 100 mesh (a maximum dimension of up to 149 micrometers) could be used.

Suitable halide activators include ammonium chloride (NH4Cl), ammonium fluoride (NH4F), and ammonium bromide (NH4Br), though the use of other halide activators is also believed to be possible. Suitable activators must be capable of reacting with aluminum in the donor material to form a volatile aluminum halide (e.g., AlCl₃, AlF₃) that reacts at the in-wall surface region 22 of the transition piece 10 to deposit aluminum, which is then diffused into at least the in-wall surface region 22 to form the diffusion aluminide coating 26. A preferred activator for a given process will depend on what type of diffusion aluminide coating desired. For example, chloride activators promote a slower reaction to produce a thinner and/or outward-type coating, whereas fluoride activators promote a faster reaction capable of producing thicker and/or inward-type coatings. For use in a slurry, the activator is in a fine powder form. In some embodiments of the invention, the activator powder is preferably encapsulated to inhibit the absorption of moisture.

Suitable binders preferably consist essentially or entirely of alcohol-based or water-based organic polymers. A preferred aspect of the invention is that the binder is able to burn off entirely and cleanly at temperatures below that required to vaporize and react the halide activator, with the remaining residue being essentially in the form of an ash that can be easily removed, for example, by forcing a gas such as air through the dilution hole 16 following the diffusion process. The use of a water-based binder generally necessitates the above-noted encapsulation of the activator powder to prevent dissolution, while the use of an alcohol-based binder does not. Commercial examples of suitable water-based organic polymeric binders include a polymeric gel available under the name Vitta Braz-Binder Gel from the Vitta Corporation. Suitable alcohol-based binders can be low molecular weight polyalcohols (polyols), such as polyvinyl alcohol (PVA). The binder may also incorporate a cure catalyst or accelerant such as sodium hypophosphite. It is foreseeable that other alcohol or water-based organic polymeric binders could also be used.

Suitable aluminide coating compositions 34 for use with this invention typically have a solids loading (donor material and activator) of about 10 to about 80 weight percent, with the balance binder. More particularly, suitable slurry compositions of this invention contain, by weight, about 35 to about 65% donor material powder, about 25 to about 60% binder, and about 1 to about 25% activator. More preferred ranges are, by weight, about 35 to about 65% donor material powder, about 25 to about 50% binder, and about 5 to about 25% activator. Within these ranges, a coating composition 34 in the form of a slurry will have consistencies that allow its selective application to the in-wall surface region 22 of the transition piece 10 by a variety of methods, including spraying, dipping, brushing, injection, etc. Also within these ranges, a coating composition 34 in the form of a tape will be sufficiently pliable to allow its selective application to the in-wall surface region 22 of the transition piece 10.

According to an advantageous aspect of the invention, the coating composition 34 can be applied to have a nonuniform thickness, yet produce a diffusion aluminide coating 26 of very uniform thickness. Another advantageous aspect of the invention is that the coating composition 34 is capable of producing the diffusion aluminide coating 26 over a broad range of diffusion treatment temperatures, generally in a range of about 1500° F. to about 2100° F. (about 815° C. to about 1150° C.). Within this broad range, the diffusion temperature can be tailored to preferentially produce either an inward or outward-type aluminide coating 26, along with the different properties associated with these different types of coatings. After applying the coating composition 34 to at least the in-wall surface region 22 of the transition piece 10, the transition piece 10 can be immediately placed in a coating chamber (retort) to perform the diffusion process. Additional coating or activator materials are not required to be present in the retort, other than what is present in the slurry. The retort is evacuated and preferably backfilled with an inert or reducing atmosphere (such as argon or hydrogen, respectively). The temperature within the retort is then raised to a temperature sufficient to burn off the binder, for example about 300° F. to about 400° F. (about 150° C. to about 200° C.), with further heating being performed to attain the desired diffusion temperature as described above, during which time the activator is volatilized, the aluminum halide is formed, aluminum is deposited on the surface of the in-wall surface region 22 within the dilution hole 16 of the transition piece 10. The transition piece 10 is held at the diffusion temperature for a duration to cause diffusion of aluminum from the coating composition 34 into the in-wall surface region 22, for example, about one to about eight hours, depending on the final thickness desired for the coating 26.

The diffusion treatment can be performed, for example, to coincide with a heat treatment of the TBC system 32 on the interior surface 24 of the transition piece 10. The coating composition 34 does not affect the TBC system 32, including any bond coat applied to promote adhesion of the ceramic layer of the TBC system 32 to interior surface 24 of the transition piece 10. The resulting coating 26 is schematically depicted in FIG. 3, and typically contains such intermetallic nickel aluminide phases such as NiAl and Ni₃Al. The aluminum content of these phases is preferably sufficient to yield an Al/Ti ratio of greater than 0.6, and more preferable greater than 1.0, to inhibit the transformation of the gamma prime phase to the detrimental eta phase. The coating 26 also provides an oxidation protection layer within the dilution hole 18 (i.e., the in-wall surface region 22) and, optionally, that portion of the exterior surface 20 immediately surrounding the hole 18, so that aluminum and other gamma prime-forming elements are not depleted from the alloy of the in-wall surface region 22 during high temperature excursions, the result of which would create a stress area for crack initiation.

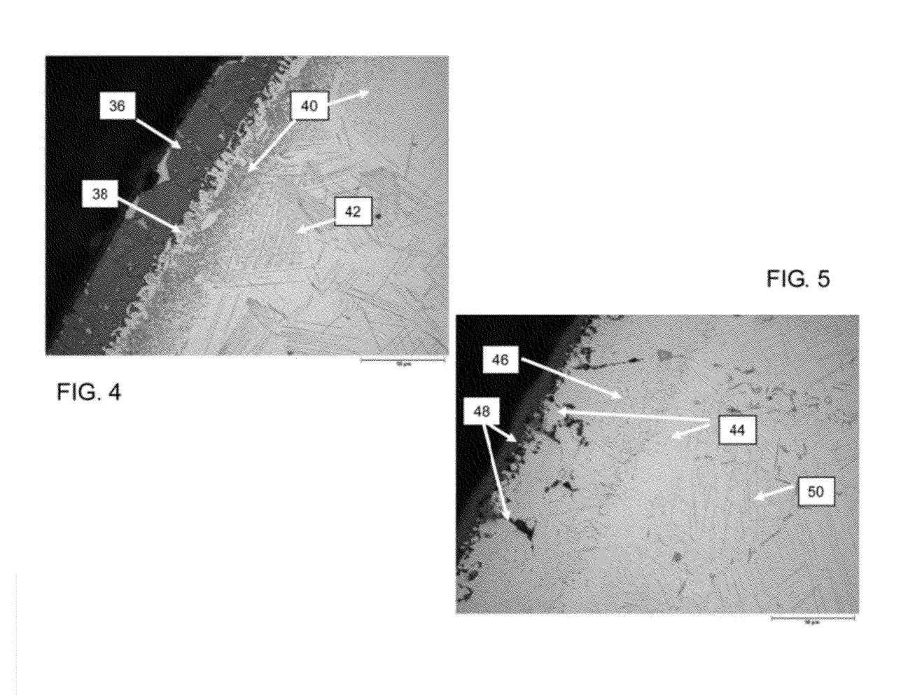

In an investigation leading to the invention, specimens formed of NIMONIC® C263 were prepared. One specimen was subjected to an aluminizing process of the type described above, and the other remained uncoated. Both specimens then underwent a thermal treat of about 1550° F. (about 845° C.) for about 4800 hours. Cross-sections of the coated and uncoated specimens are shown in FIGS. 4 and 5, respectively. FIG. 4 evidences that the substrate region underlying the aluminide coating 36 and its diffusion zone 38 contains a fine dispersion of gamma prime precipitates 40 and eta precipitates 42. In contrast, FIG. 5 evidences that the uncoated specimen contains regions 44 that have been depleted of gamma prime precipitates. Furthermore, oxide precipitates 46 and oxidation damage 48 are visible in FIG. 5. From these results, it was concluded that the diffusion aluminide coating 36 had greatly inhibited depletion of the gamma prime precipitates 40, which was believed to be the result of a reservoir of aluminum provided by the aluminide coating 36. The coating 36 appeared to have reduced or eliminated the depletion of gamma prime precipitates 40 by inhibiting oxidation damage and preventing the transformation of gamma prime precipitates 40 into the less ductile eta phase (42 in FIG. 4, 50 in FIG. 5). Moreover, based on the previously-noted correlation between depletion of gamma prime precipitates and cracking, it was concluded that the coated specimen would be more resistant to cracking than the uncoated specimen.

While the invention has been described in terms of a particular embodiment, it is apparent that other forms could be adopted by one skilled in the art. Accordingly, the scope of the invention is to be limited only by the following claims.

1. A method of maintaining surface-related properties of a gas turbine combustor component having a wall formed of a nickel-base alloy containing aluminum and a gamma prime precipitate strengthening phase, interior and exterior surfaces defined by the wall, and at least one hole in the wall and extending from the exterior surface to the interior surface so that an in-wall surface region of the wall defines the hole and the hole fluidically connects the interior and exterior surfaces of the combustor component, the method comprising:
selectively applying a diffusion coating composition at least within the hole; and then
heating the diffusion coating composition to form a diffusion aluminide coating in at least the in-wall surface region of the wall, the diffusion aluminide coating comprising a diffusion zone that contains aluminum intermetallics, the aluminum intermetallics providing a reservoir for aluminum that is depleted from the nickel-base alloy, the diffusion zone containing a sufficient amount of the aluminum intermetallics to inhibit depletion of the gamma prime precipitates in the wall and inhibit degradation and cracking in the in-wall surface region surrounding the hole.

2. The method according to claim 1, wherein the combustor component further has a ceramic coating on the interior surface, and the heating step further comprises a thermal heat treatment of the ceramic coating.

3. The method according to claim 1, wherein the diffusion coating composition is a tape or slurry.

4. The method according to claim 1, wherein the diffusion coating composition comprises a donor material containing metallic aluminum, a halide activator, and a binder containing an organic polymer, and the diffusion coating composition does not contain inert fillers or inorganic binders.

5. The method according to claim 1, wherein the diffusion coating composition consists of at least one donor material containing metallic aluminum, at least one halide activator, and at least one organic polymer binder.

6. The method according to claim 1, wherein the nickel-based alloy contains, by weight, 19-21% chromium, 19-21% cobalt, 5.6-6.1% molybdenum, 1.9-2.4% titanium, 0-0.6% aluminum, 2.4-2.8% Al+Ti, 0.04-0.08% carbon, 0-0.6% manganese, 0-0.2% copper, 0-0.005% boron, 0-0.7% iron, 0-0.4% silicon, the balance nickel and incidental impurities.

7. The method according to claim 1, wherein the combustor component is a transition piece.

8. The method according to claim 7, wherein the hole is a dilution hole of the transition piece.

9. The method according to claim 7, further comprising installing the transition piece in an industrial gas turbine engine.

10. The method according to claim 9, further comprising operating the gas turbine engine, wherein the diffusion aluminide coating inhibits depletion of the gamma prime precipitates in the wall and inhibits degradation and cracking in the in-wall surface region surrounding the hole.

11. A combustor component produced by the method according to claim 1.

12. The combustor component according to claim 11, wherein the combustor component is a transition piece.

13. The combustor component according to claim 12, wherein the hole is a dilution hole of the transition piece.

14. The combustor component according to claim 12, wherein the transition piece is installed in an industrial gas turbine engine.

15. A method of maintaining surface-related properties of a transition piece of an industrial gas turbine engine, the transition piece having a wall formed of a nickel-base alloy containing aluminum and a gamma prime precipitate strengthening phase, interior and exterior surfaces defined by the wall, and at least one hole in the wall and extending from the exterior surface to the interior surface so that an in-wall surface region of the wall defines the hole and the hole fluidically connects the interior and exterior surfaces of the combustor component, the method comprising:
depositing a ceramic coating on the interior surface of the transition piece;
selectively applying a diffusion coating composition at least within the hole;
heating the transition piece to heat treat the ceramic coating and diffuse the aluminum of the diffusion coating composition into the wall and form a diffusion aluminide coating in at least the in-wall surface region of the wall, the diffusion aluminide coating comprising a diffusion zone that contains aluminum intermetallics, the aluminum intermetallics providing a reservoir for aluminum that is depleted from the nickel-base alloy;
installing the transition piece in a gas turbine engine; and then
operating the gas turbine engine, the diffusion zone containing a sufficient amount of the aluminum intermetallics to achieve an Al/Ti ratio of greater than 0.6 in the in-wall surface region, inhibit depletion of the gamma prime precipitates in the wall, and inhibit degradation and cracking in the in-wall surface region surrounding the hole.

16. The method according to claim 15, wherein the diffusion coating composition is a tape or slurry.

17. The method according to claim 16, wherein the diffusion coating composition comprises a donor material containing metallic aluminum, a halide activator, and a binder containing an organic polymer, and the diffusion coating composition does not contain inert fillers or inorganic binders.

18. The method according to claim 16, wherein the diffusion coating composition consists of at least one donor material containing metallic aluminum, at least one halide activator, and at least one organic polymer binder.

19. The method according to claim 15, wherein the nickel-based alloy contains, by weight, 19-21% chromium, 19-21% cobalt, 5.6-6.1% molybdenum, 1.9-2.4% titanium, 0-0.6% aluminum, 2.4-2.8% Al+Ti, 0.04-0.08% carbon, 0-0.6% manganese, 0-0.2% copper, 0-0.005% boron, 0-0.7% iron, 0-0.4% silicon, the balance nickel and incidental impurities.

20. The method according to claim 15, wherein the hole is a dilution hole of the transition piece.
